(19) United States
(12) Patent Application Publication
(10) Pub. No.: US 2018/0260031 A1
(43) Pub. Date: Sep. 13, 2018

(54) METHOD FOR CONTROLLING DISTRIBUTION OF MULTIPLE SUB-SCREENS AND DEVICE USING THE SAME

(71) Applicants: NANNING FUGUI PRECISION INDUSTRIAL CO., LTD., Nanning (CN); HON HAI PRECISION INDUSTRY CO., LTD., New Taipei (TW)

(72) Inventor: PO-YU LIN, New Taipei (TW)

(21) Appl. No.: 15/452,867

(22) Filed: Mar. 8, 2017

(51) Int. Cl. G06F 3/01; G06F 3/0485; G06F 3/0484

(52) U.S. Cl. CPC G06F 3/017; G06F 3/012; G06F 2203/04806; G06F 3/04845; G06F 3/0485

(57) ABSTRACT

A method for controlling distribution of multiple dub-screens on a single display, applied on an electronic device. The sub-screen at least comprises a first sub-screen and a second sub-screen. The first sub-screen at least comprises a first operator. The second sub-screen comprises a second operator. The method comprises certain steps. Tracking a first head position of the first operator relative to the first sub-screen, and calculating a first face center point of the first head position. Tracking a second head position of the second operator relative to the second sub-screen, and calculating a second face center point of the second head position. Adjusting distributions of the first sub-screen and the second sub-screen according to the first face center point and the second face center point. A device of controlling distribution of multiple sub-screens is provided.

### CROSS-REFERENCE TO RELATED APPLICATIONS

The application is related to a co-pending application entitled, “METHOD FOR DISPLAYING SUB-SCREEN AND DEVICE USING THE SAME” (Attorney. Docket No. US59434).

### FIELD

The subject matter herein generally relates to display technology.

### BACKGROUND

Different users can use their own sub-screens of a display screen of a television. Conventionally, a sub-screen mode is switched into by using special keys of a remote controller, the distribution of the sub-screens cannot be adjusted dynamically.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a flowchart of an exemplary embodiment of a method of controlling distribution of multiple sub-screens.

FIG. 2 is a schematic diagram of an exemplary embodiment of a sub-screen controlling gesture.

FIGS. 3-1-3-3 show exemplary embodiments for establishing sub-screens.

FIG. 3-4 is a schematic diagram of an exemplary embodiment for sub-screen merging.

FIGS. 3-5-3-6 show exemplary embodiments for sub-screen deleting.

FIG. 3-7 is a schematic diagram of an exemplary embodiment for sub-screen suspending or hiding.

FIG. 3-8 is a schematic diagram of an exemplary embodiment for controlling sub-screen distribution or playing such sub-screens.

FIGS. 4-1-4-3 show exemplary embodiments for distributing sub-screens.

FIG. 5 is a flowchart of an exemplary embodiment of a method for distributing sub-screens.

FIGS. 6a-6b show exemplary embodiments of processes of calculating the best sub-screen configuration manner.

FIG. 7 is a schematic diagram of an exemplary embodiment of operating gestures for sub-screens.

FIG. 8 is a block diagram of an exemplary embodiment of an electronic device for achieving the method of controlling distribution of multiple sub-screens.

FIG. 9 is a block diagram of an exemplary embodiment of a device for controlling distribution of multiple sub-screens.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

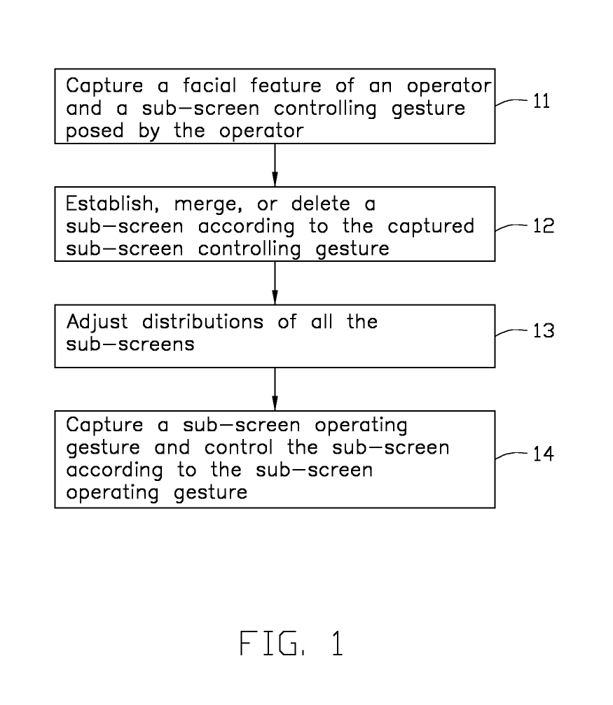

FIG. 1 shows a flowchart of an exemplary embodiment of a method of controlling distribution of multiple sub-screens. The method of controlling distribution of multiple sub-screens is applied on an electronic device. The electronic device can be, but is not limited to, a smart television, a telephone, a tablet computer, or other suitable electronic device having displaying and human-computer interaction function. As shown in FIG. 1, the method of controlling distribution of multiple sub-screens can include steps 11-14 as follows.

At step 11, a capturing unit captures at least one facial feature of at least one operator and a sub-screen controlling gesture posed by the at least one operator within a predefined area of the electronic device.

In detail, the capturing unit is mounted on any location of the electronic device or located anywhere adjacent to the electronic device. The capturing unit can be, but is not limited to, a camera, a three-dimensional depth sensor, or the like. When the operator is located in front of the electronic device and watching the electronic device, the capturing unit can capture the facial feature of the operator, and also a sub-screen controlling gesture posed by the operator.

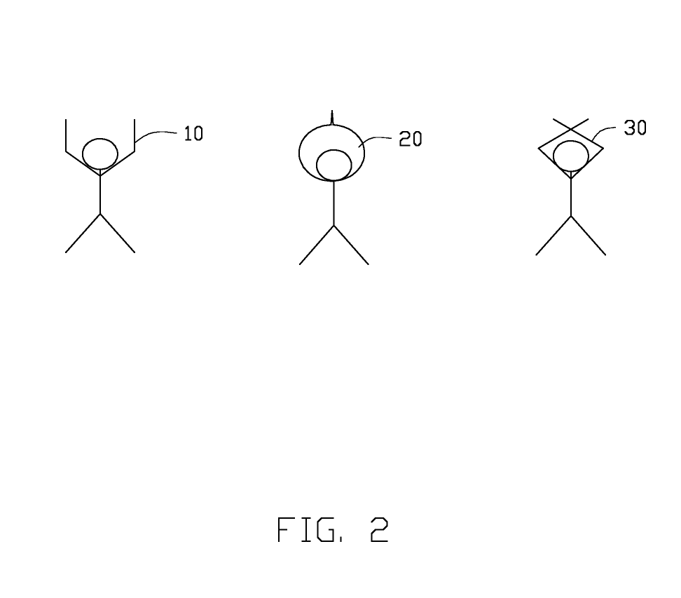

As shown in FIG. 2, the sub-screen controlling gestures can include a sub-screen establishing gesture 10, a sub-screen merging gesture 20, and a sub-screen deleting gesture 30. Therein, the sub-screen establishing gesture 10 is two hands held over the head of the operator himself without touching one another. The sub-screen merging gesture 20 is the two hands clasping over the head of the operator himself. The sub-screen deleting gesture 30 is the two hands crossing over the head of the operator himself.

At step 12, the electronic device is controlled to establish, merge, or delete a sub-screen according to the captured sub-screen controlling gesture, and store a relationship between the facial feature of the operator and the captured sub-screen.

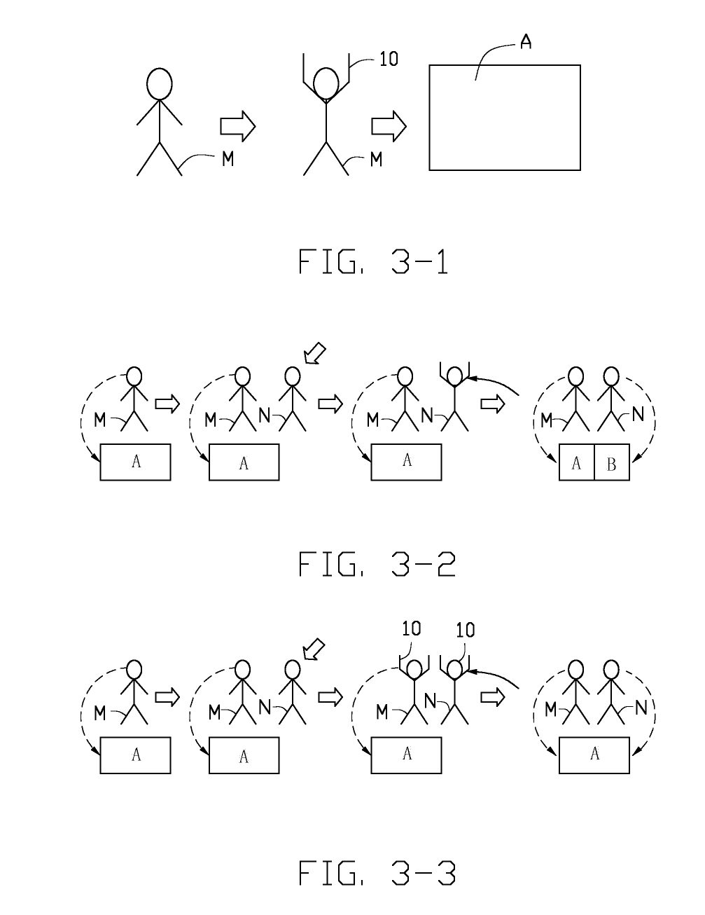

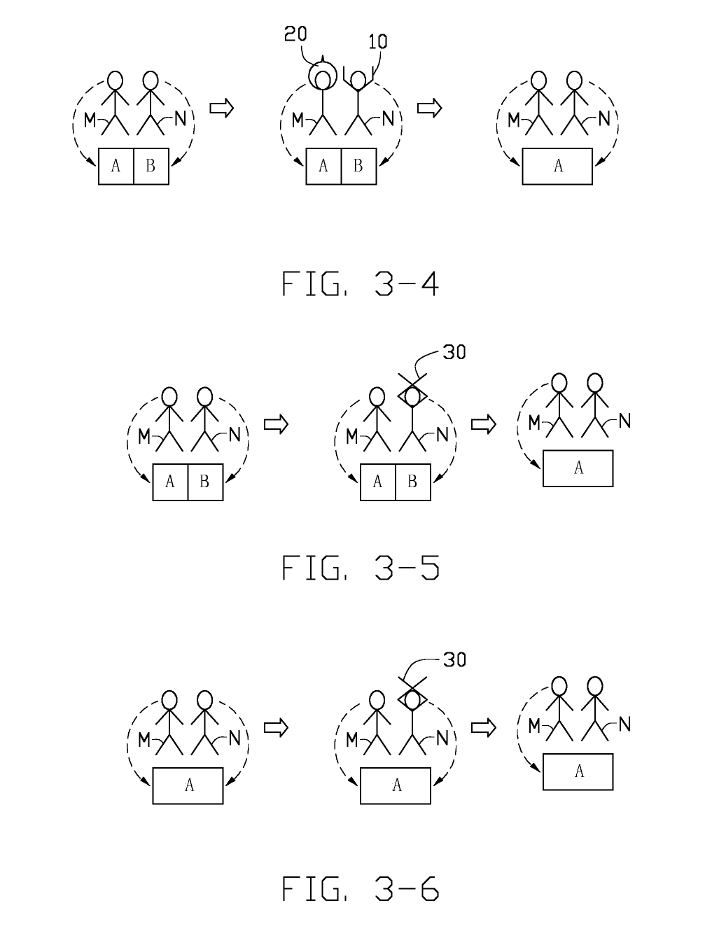

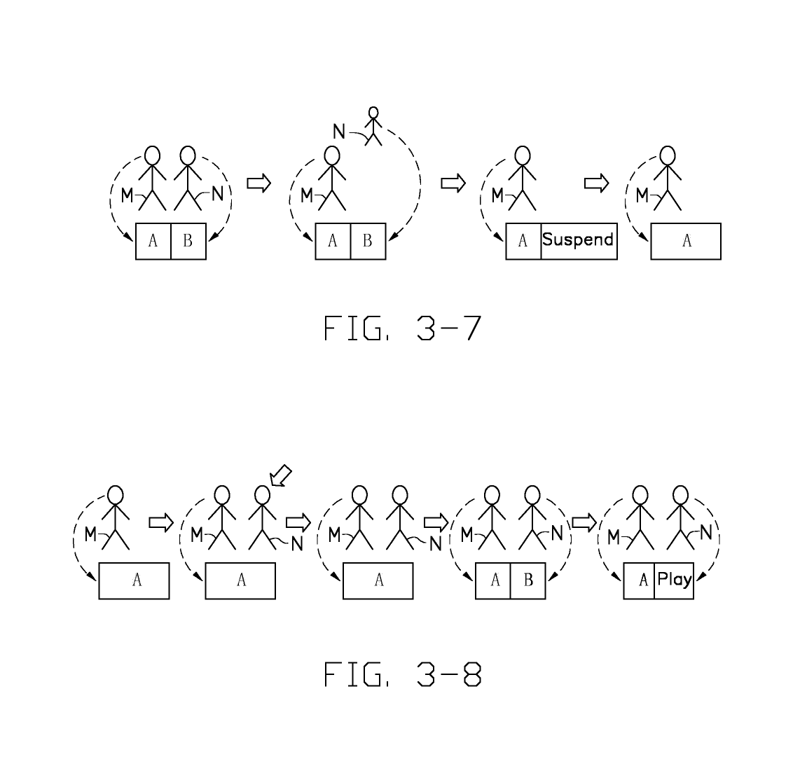

As shown in FIG. 3-1, when only the first operator M enters the predefined area of the electronic device and poses the sub-screen establishing gesture 10. The capturing unit captures the sub-screen establishing gesture 10 posed by the first operator M and the facial feature of the first operator M. The electronic device is controlled to establish a first sub-screen A corresponding to the first operator M according to the sub-screen establishing gesture 10 posed by the first operator M. The electronic device is further controlled to store a relationship between the facial feature of the first operator M and the first sub-screen A. Therein, the first sub-screen A can cover the full screen of the electronic device. For example, the first sub-screen A can display a basketball game.

As shown in FIG. 3-2, when the first operator M is within the predefined area of the electronic device and watching the first sub-screen A, another second operator N may enter the predefined area of the electronic device and pose the sub-screen establishing gesture 10. The capturing unit captures the sub-screen establishing gesture 10 posed by the second operator N and the facial feature of the second operator N. The electronic device is controlled to establish a second sub-screen B corresponding to the second operator N according to the sub-screen establishing gesture 10 posed by the second operator N. The electronic device is further controlled to store a relationship between the facial feature of the second operator N and the second sub-screen B. Therein, the first sub-screen A and the second sub-screen B are cooperatively cover the full screen of the electronic device. For example, the first sub-screen A displays a basketball game, the second sub-screen B displays a cartoon show.

As shown in FIG. 3-3, when the first operator M is in the predefined area of the electronic device and watching the first sub-screen A. Another second operator N enters the predefined area of the electronic device and poses the sub-screen establishing gesture 10 at the same time as the first operator M, who is also posing the sub-screen establishing gesture 10. The capturing unit captures the sub-screen establishing gesture 10 posed by the first operator M and the facial feature of the second operator N. The electronic device is controlled to add the second operator N as an operator of the first sub-screen A according to the sub-screen establishing gesture 10 posed by the first operator M and the sub-screen establishing gesture 10 posed by the second operator N. The electronic device is further controlled to store a relationship between the facial feature of the second operator N and the first sub-screen A in addition to the relationship between first operator M and first sub-screen A.

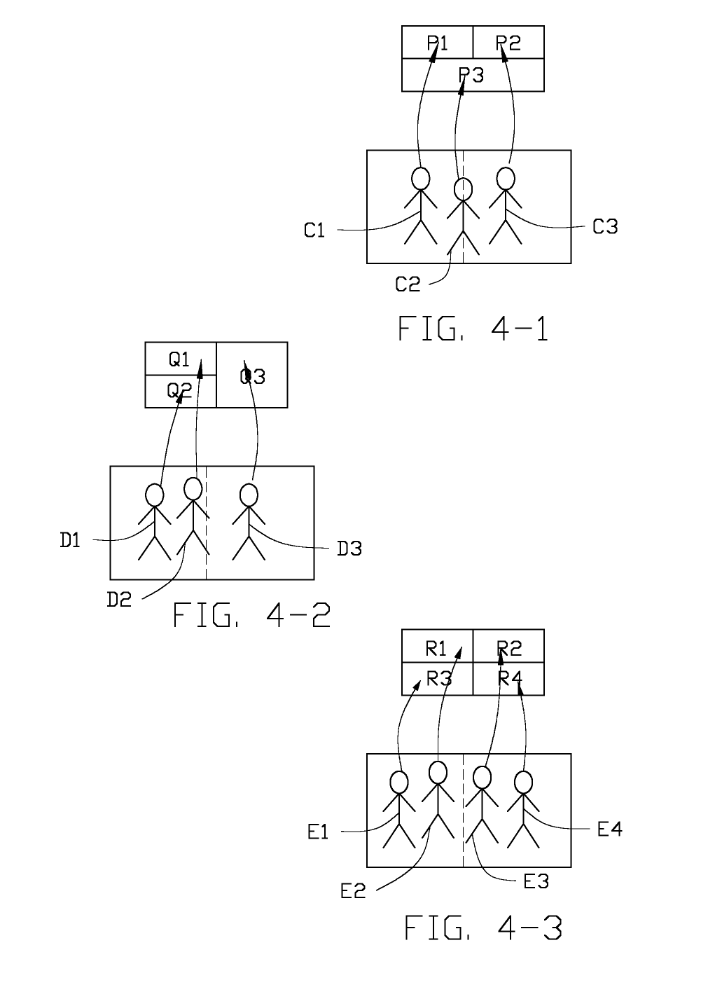

As shown in FIG. 3-4, when the first operator M is in the predefined area and watching the first sub-screen A, and the second operator N is in the predefined area of the electronic device and watching the second sub-screen B. If the second operator N poses the sub-screen establishing gesture 10 while the first operator M poses the sub-screen merging gesture 20 at the same time, the capturing unit captures the sub-screen establishing gesture 10 posed by the second operator N and the sub-screen merging gesture 20 posed by the first operator M. The electronic device is controlled to add the second operator N as an operator of the first sub-screen A according to the sub-screen establishing gesture 10 posed by the second operator N and the sub-screen merging gesture 20 posed by the first operator M. The electronic device is further controlled to store the relationship between the facial feature of the second operator N and the first sub-screen A, and delete the relationship between the facial feature of the second operator N and the second sub-screen B. At this time, the first sub-screen A fully covers the screen of the electronic device.

In at least one exemplary embodiment, when one of at least two operators, each having their own sub-screen, is posing the sub-screen merging gesture 20, and the other or another operators pose the sub-screen establishing gesture 10, the capturing unit captures the sub-screen establishing gesture 10 posed by the one of at least two operators and the sub-screen merging gestures 20 posed by the other (or another) operators. The electronic device is controlled to add the other/another operator as an co-operator of the sub-screen related to the one of at least two operators according to the sub-screen establishing gesture 10 posed by the one of at least two operators and the sub-screen merging gestures 20 posed by the other (or another) operators. The electronic device is further controlled to store a relationship between the facial features of the other (or another) operators and the sub-screen related to the one of at least two operators.

As shown in FIG. 3-5, when the first operator M is in the predefined area of the electronic device and watching the first sub-screen A, and the second operator N is in the predefined area of the electronic device and watching the second sub-screen B. If the second operator N poses the sub-screen deleting gesture 30, as the second sub-screen B has no other related operators, the electronic device is controlled to delete the second sub-screen B, and further delete the relationship between the facial feature of the second operator N and the second sub-screen B according to the sub-screen deleting gesture 30 posed by the second operator N. At this time, as there are no other sub-screens, the first sub-screen A is expanded to fully cover the screen of the electronic device.

As shown in FIG. 3-6, when the first operator M and the second operator N are in the predefined area and both watching the first sub-screen A together, the second operator N may pose the sub-screen deleting gesture 30. Since the first sub-screen A has another related operator (first operator M), the electronic device is controlled to delete the relationship between the facial feature of the second operator N and the first sub-screen A.

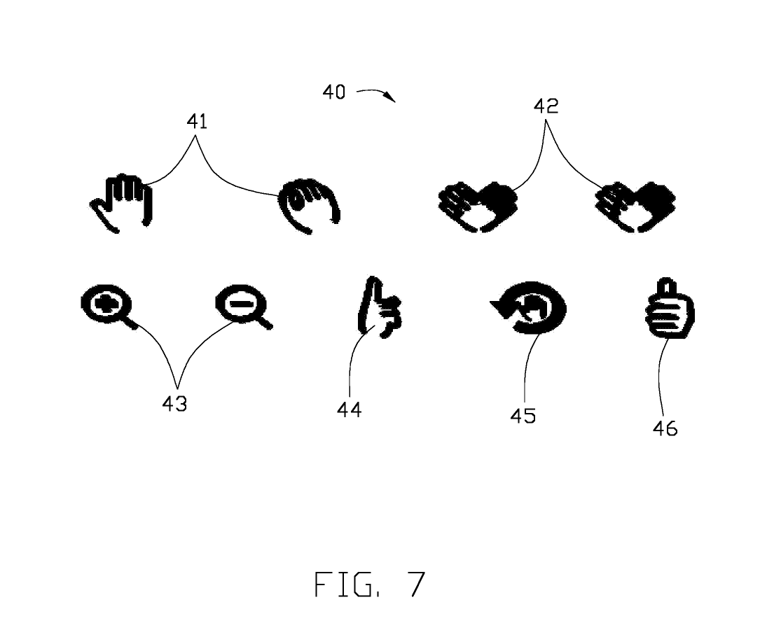

As shown in FIG. 3-7, the first operator M is in the predefined area of the electronic device and watching the first sub-screen A while the second operator N is in the predefined area of the electronic device and watching the second sub-screen B at the same time. If the second operator N leaves, the electronic device is controlled to stop, hide or suspend the second sub-screen B, as the second sub-screen B has no other related operator.

As shown in FIG. 3-8, when the second operator N leaves, the second sub-screen B is hidden, leaving the first operator M to watch the full screen size of the first sub-screen A. When the second operator N returns, the capturing unit is controlled to capture and identify the facial feature of the second operator N, and the electronic device is controlled to display the second sub-screen B again.

As the size of the electronic device is limited, the number of the sub-screens is limited. The limit can be a predefined value, such as six. When the number of the sub-screens is equal to the predefined value, a new sub-screen is not allowed to be established, and the new operator can only be allowed and added as an co-operator of a sub-screen.

As the processing speed of the electronic device is also limited, the number of total operators and co-operators cannot be greater than a predefined value, such as ten. When the total number of operators and co-operators is equal to ten, a new operator cannot be allowed.

In at least one exemplary embodiment, a small icon of an operator relative to a sub-screen can be displayed on a top right corner of the sub-screen. In at least one exemplary embodiment, the small icon of the operator relative to the displaying sub-screen can be displayed on the top right corner of the sub-screen. The small icon relating to the operator of a hidden sub-screen can be displayed on a lower right corner of the screen of the electronic device.

In at least one exemplary embodiment, the small icon of the operator relative to the displaying sub-screen can be displayed with one color. The small icon of the operator relative to the hidden sub-screen can be displayed with a different color.

At step 13, the electronic device is controlled to adjust distribution of all of the sub-screens. For example, the electronic device is controlled to track a first head position of the first operator M related to the first sub-screen A, and calculate a first face center point of the first head position. The electronic device is further controlled to track a second head position of the second operator N related to the second sub-screen B, and calculate a second face center point of the second head position. The distribution of all of the sub-screens on the screen is adjusted according to movements of the first face center point and the second face center point, for example.

In detail, the functions for adjusting the distribution of all of the sub-screens can include, but is not limited to, establishing a new sub-screen, adding new operator to the sub-screen, merging the sub-screen, and deleting the sub-screen. Such functions also include the departure of any operator, the return of an operator, and the relocation of any operator, where such operator stays at the new location for more than a predefined time duration, such as one minute.

As shown in FIG. 4-1, there are three sub-screens P1, P2, P3 and three operators C1, C2, C3. The distance between the operator C1 and C2 is approximately equal to the distance between the operator C2 and C3. The operator C2 is located between the operator C1 and C3. The head positions of the operators C1 and C3 are lower than that of the operator C2. Therefore, the distribution of the three sub-screens is two sub-screens located high on the screen and another sub-screen located below the two high sub-screens. The operator C1 located on left hand side is related to the sub-screen P1 located on top left corner. The operator C3 located on right hand side is related to sub-screen P2 located on top right corner. The short operator C2 located in the middle is related to the sub-screen P3 located at the bottom of the screen.

As shown in FIG. 4-2, the three sub-screens Q1, Q2, Q3 and the three operators D1, D2, D3. The operator D2 is located between the operator D1 and the operator D3. The distance between the operator D2 and the operator D1 is less than the distance between the operator D2 and the operator D3. The head position of the operator D2 is higher than those of the operators D1 and D3. Therefore, the distribution of the three sub-screens is two sub-screens located left side on the screen and another sub-screen located right on the screen. The operator D2 is related to the sub-screen Q1. The operator D1 is related to the sub-screen Q2. The operator D3 is related to the sub-screen Q3.

As shown in FIG. 4-3, there are four sub-screens R1, R2, R3, R4 and four operators E1, E2, E3, E4. The four operators E1, E2, E3, E4 are seating in sequence. The distance between every two adjacent operators is approximately the same. The head positions of the two middle operators E2, E3 are higher than the head positions of the other two operators E1, E4. Therefore, the distribution of the four sub-screens R1, R2, R3, R4 is two sub-screens located on the top of the screen and another two sub-screens located at the bottom of the screen. The two middle operators E2, E3 are related to the upper sub-screens R1 and R2 located on top left corner and top right corner respectively. The other two operators E1 and E4 are related to lower sub-screens R3 and R4 located bottom left corner and bottom right corner respectively.

As shown in FIG. 5, in detail, a method of controlling distribution of multiple sub-screens can include steps as follows.

At step 131, the electronic device determines whether the number of the sub-screens is greater than one, if yes, the process goes to step 132, otherwise, the process goes to end.

At step 132, the face center point of the head positions of all the operators relative to the number of sub-screens are calculated.

At step 133, the face center point of the head positions related to the corresponding sub-screens into a number of distribution manners are substituted to get a best distribution manner. Therein, the best distribution manner is that a sum of each distance between center of any first sub-screen and any face center point is the minimum (i.e., the smallest sum).

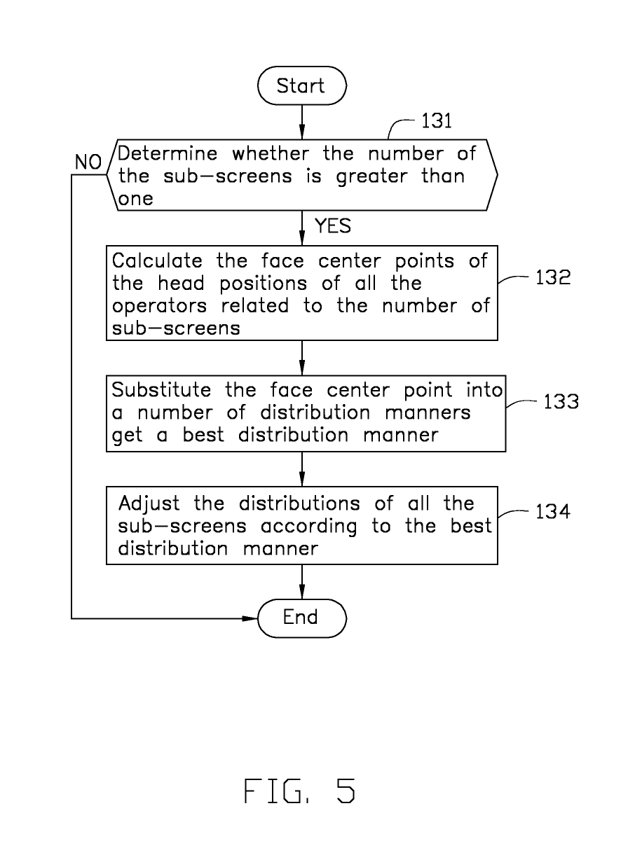

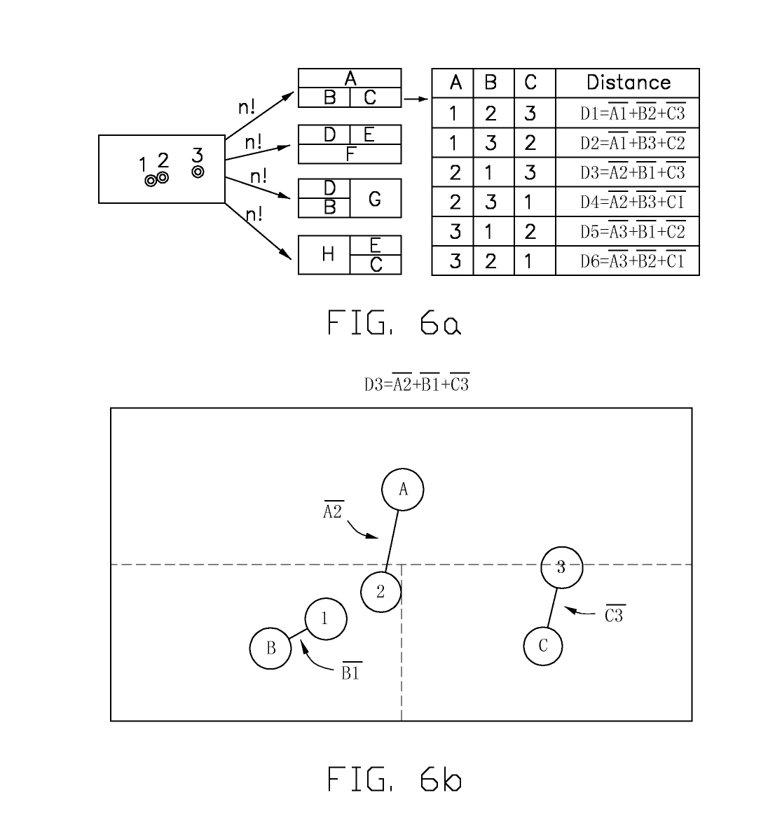

As referred to FIGS. 6a and 6b, for example, the face center points of the head positions of all the operators relative to three sub-screens are position 1, position 2 and position 3, respectively. In at least one exemplary embodiment, the above face center point can be a face center point of one operator or at least two operators which are related to one sub-screen. In at least one exemplary embodiment, the distribution of three sub-screens can include four distribution ways, that is, one sub-screen located on top of two sub-screens, two sub-screens located on top of a sub-screen, two sub-screens located on the left side of one sub-screen, or one sub-screen located on left side of two sub-screens. In at least one exemplary embodiment, in each distribution style, the sub-screens can have a number of ways of being configured (distribution manners). In detail, the number of the distribution manners is a factorial of the number of sub-screens. For example, the distribution manners of three sub-screens is the factorial of three (i.e., 3!), which is 6. Another example, the distribution manners of four sub-screens is the factorial of four (i.e., 4!), which is 24. The best distribution manner is that a sum of each distance between the center of any sub-screen and the any face center point 1, 2, or 3 is the minimum. For example, when the distribution manner is the one sub-screen located on top of two sub-screens, provided that the face center point 1 is related to the first sub-screen A, the face center point 2 is related to the second sub-screen B, and the face center point 3 is related to the sub-screen C, the distance D1=A̅1̅+B̅2̅+C̅3̅. Provided that the face center point 1 is related to the first sub-screen A, the face center point 2 is related to the sub-screen C, the face center point 3 is related to the second sub-screen B, the distance D2=A̅1̅+B̅3̅+C̅2̅. Provided that the face center point 2 is related to the first sub-screen A, the face center point 1 is related to the second sub-screen B, and the face center point 3 is related to the second sub-screen B, the distance D3=A̅2̅+B̅1̅+C̅3̅. Provided that the face center point 2 is related to the first sub-screen A, the face center point 3 is related to the second sub-screen B, and the face center point 1 is related to the second sub-screen C, the distance D4=A̅2̅+B̅3̅+C̅1̅. Provided that the face center point 3 is related to the first sub-screen A, the face center point 1 is related to the second sub-screen B, and the face center point 2 is related to the second sub-screen C, the distance D5=A̅3̅+B̅1̅+C̅2̅. Provided that the face center point 3 is related to the first sub-screen A, the face center point 2 is related to the second sub-screen B, and the face center point 1 is related to the second sub-screen C, the distance D6=A̅3̅+B̅2̅+C̅1̅. And then, the minimum distance is calculated. The best distribution manner is the minimum distance corresponded to. In the present exemplary embodiment, as shown in FIG. 6b, the minimum distance among D1, D2, D3, D4, D5, and D6 is distance D3=A̅2̅+B̅1̅+C̅3̅.

At step 134, the distributions of all the sub-screens are adjusted according to the best distribution manner having the minimum sum.

In at least one exemplary embodiment, the sub-screen distribution method further comprises step 14.

At step 14, the sub-screen operating gesture 40 posed by the first operator M related to the first sub-screen A or posed by the second operator N related to the second sub-screen B is captured. The corresponding first sub-screen A or second sub-screen B is controlled according to the captured sub-screen operating gesture 40. Therein, the sub-screen operating gesture 40 can include, but is not limited to, a mouse simulating gesture 41, a scroll gesture 42, a zoom gesture 43 (only a represent but not a schematic diagram), a mute gesture 44, a return gesture 45, a homepage gesture 46, and so on.

In detail, the mouse simulating gesture 41 can include a mouse moving gesture, a mouse clicking gesture, and a mouse dragging gesture. The mouse moving gesture can be movement of an open palm. The mouse clicking gesture can be movement of the clenched fist. The mouse dragging gesture can be clenching and moving the fist. The scroll gesture 42 can include a scroll-up gesture and scroll-down gesture. The scroll-up gesture can be hand waving towards left. The scroll-down gesture can be hand waving towards right. The zoom gesture 43 can include a zoom-in gesture and a zoom-out gesture. The zoom-in gesture can be two hands moving away from each other. The zoom-out gesture can be the two hands moving close to each other. The mute gesture 44 can be placing an index finger in front of the user's mouth. The return gesture 45 can be palm turning around anticlockwise. The homepage gesture 46 can be a thumb pointing up.

When the mouse simulating gesture 41 is captured, a mouse controlling command, such as a mouse moving command, a mouse clicking command or a mouse dragging command, can be transmitted to the first sub-screen A related to the first operator M or the second sub-screen B related to the second operator N posing the mouse simulating gesture 41. The cursor can be controlled to act on the first sub-screen A related to the first operator M or the second sub-screen B related to the second operator N posing the mouse simulating gesture 41.

When the scroll-up gesture is captured, a scroll-up command can be transmitted to the first sub-screen A related to the first operator M or the second sub-screen B related to the second operator N posing the scroll-up gesture, and the first sub-screen A related to the first operator M or the second sub-screen B related to the second operator N posing the scroll-up gesture can be controlled to page up.

When the scroll-down gesture is captured, a scroll-down command can be transmitted to the first sub-screen A related to the first operator M or the second sub-screen B related to the second operator N posing the scroll-down gesture, and the first sub-screen A related to the first operator M or the second sub-screen B related to the second operator N posing the scroll-down gesture can be controlled to page down.

When the zoom-in gesture is captured, a zoom-in command can be transmitted to the first sub-screen A related to the first operator M or the second sub-screen B related to the second operator N posing the zoom-in gesture, and the first sub-screen A related to the first operator M or the second sub-screen B related to the second operator N posing the zoom-in gesture can be controlled to be zoomed.

When the zoom-out gesture is captured, a zoom-out command can be transmitted to the first sub-screen A related to the first operator M or the second sub-screen B related to the second operator N posing the zoom-out gesture, and the first sub-screen A related to the first operator M or the second sub-screen B related to the second operator N posing the zoom-out gesture can be controlled to zoom out.

When the mute gesture 44 is captured, a mute command can be transmitted to the first sub-screen A related to the first operator M or the second sub-screen B related to the second operator N posing the mute gesture 44, and the first sub-screen A related to the first operator M or the second sub-screen B related to the second operator N posing the mute gesture 44 can be controlled to be muted.

When the return gesture 45 is captured, a return command can be transmitted to the first sub-screen A related to the first operator M or the second sub-screen B related to the second operator N posing the return gesture 45, and the first sub-screen A related to the first operator M or the second sub-screen B related to the second operator N posing the return gesture 45 can be controlled to return to previous page.

When the homepage gesture 46 is captured, a homepage command can be transmitted to the first sub-screen A related to the first operator M or the second sub-screen B related to the second operator N posing the homepage gesture 46, and the first sub-screen A related to the first operator M or the second sub-screen B related to the second operator N posing the homepage gesture 46 can be controlled to return to homepage.

In at least one exemplary embodiment, a small icon of an operator relative to a sub-screen can be displayed on a top right corner of the sub-screen. Therein, in at least one exemplary embodiment, the small icon of the operator relative to the displaying sub-screen can be displayed on the top right corner of the sub-screen. However, the small icon of the operator relative to the hidden sub-screen can be displayed on a lower right corner of the screen of the electronic device.

In at least one exemplary embodiment, the small icon of the operator relative to the displaying sub-screen can be displayed with one color. The small icon of the operator relative to the hidden sub-screen can be displayed with a different color.

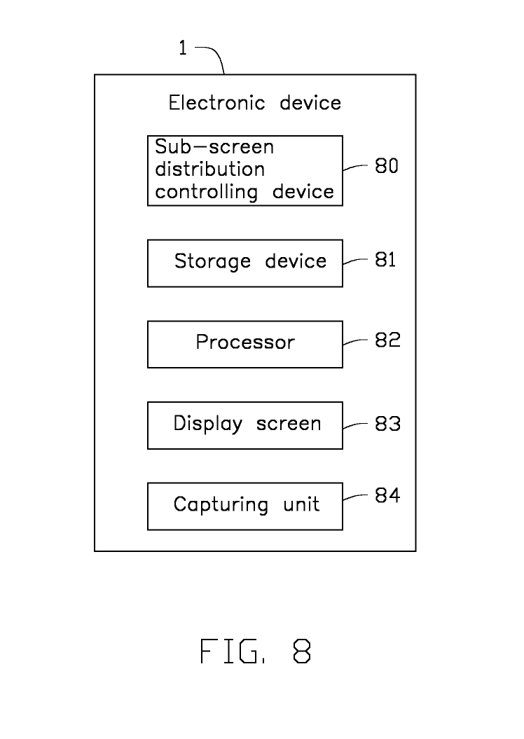

FIG. 8 illustrates an electronic device 1 for achieving the method of controlling distribution of multiple sub-screens. The device of controlling distribution of multiple sub-screens 80 is set on the electronic device 1. The electronic device 1 can further include a storage device 81, a processor 82, a display screen 83, and a capturing unit 84. Preferably, the method of controlling distribution of multiple sub-screens is achieved by the device of controlling distribution of multiple sub-screens 80.

The electronic device 1 can be electronic equipment which can execute numerical computation and/or information processing automatically according to the predetermined or stored instructions.

The device of controlling distribution of multiple sub-screens 80 can capture a facial feature of an operator and a sub-screen controlling gesture posed within the predefined area by the operator, and control the electronic device to establish, merge, or delete a sub-screen according to the captured sub-screen controlling gesture, and store the relationship between the facial feature of the operator and the sub-screen. The device of controlling distribution of multiple sub-screens 80 can track head positions of all operators relative to corresponding sub-screens, calculate a face center point of the head positions of all the operators relative to each of the sub-screens, and adjust distributions of all the sub-screens according to the face center point of each sub-screen when the number of the sub-screens is greater than one. The device of controlling distribution of multiple sub-screens 80 can further capture the sub-screen operating gesture 40 posed by the operator relative to any sub-screen, and control the first sub-screen according to the sub-screen operating gesture 40.

The storage device 81 can be configured to store procedure code of each section of the device of controlling distribution of multiple sub-screens 80.

In at least one exemplary embodiment, the storage device 81 can be an internal storage system, such as a flash memory, a random access memory (RAM) for temporary storage of information, and/or a read-memory (ROM) for permanent storage of information.

In at least one exemplary embodiment, the storage device 81 can also be a storage system, such as a hard disk, a storage card, or a data storage medium. The storage device 81 can include volatile and/or non-volatile storage devices.

In at least one exemplary embodiment, the storage device 81 can include two or more storage devices such that one storage device is a memory and the other storage device is a hard drive. Additionally, the storage device 81 can be either entirely or partially external relative to the electronic device 1.

The processor 82 can include one or more micro-processors, digital processors, or, one or micro-controllers, or other suitable processor.

The display screen 83 can be a touch screen or a non-touch screen.

The capturing unit 84 can be mounted on the display screen 83 of the electronic device 1, or located adjacent to the electronic device 1. The capturing unit 84 can be a camera, and/or three-dimensional motion sensors, or so on. The capturing unit 84 can be configured to capture facial features, gestures, and/or limb movements of the operator located at the predefined area of the electronic device 1.

In at least one exemplary embodiment, the capturing unit 84 can include a number of cameras, and/or a number of three-dimensional motion sensors to obtain a wider visual angle. The cameras and/or the three-dimensional motion sensors can be located on any location of the electronic device 1 or located anywhere adjacent to the electronic device 1. The cameras and/or the three-dimensional motion sensors can capture pictures from a number of aspects and the pictures can be merged into a singles picture for later analysis.

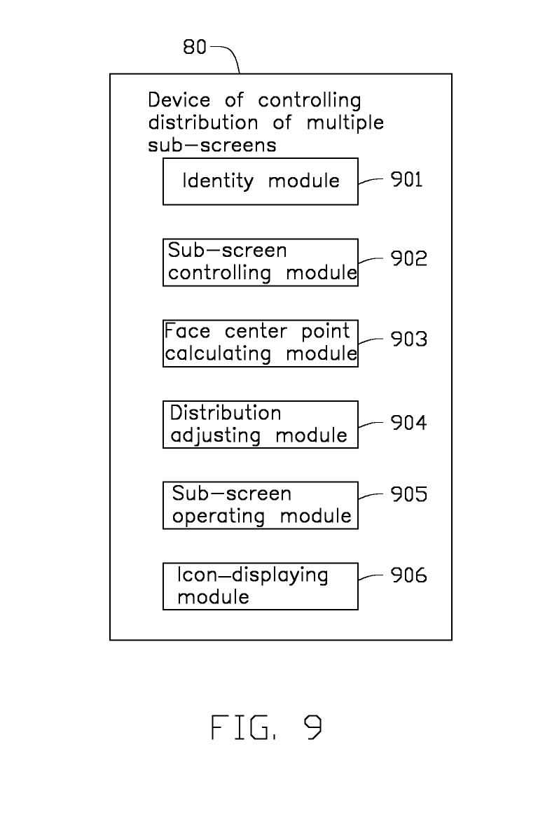

FIG. 9 is a block diagram of a device of controlling distribution of multiple sub-screens. The device of controlling distribution of multiple sub-screens 80 is provided to carry out the method of FIG. 1. The device of controlling distribution of multiple sub-screens 80 can include an identity module 901, a sub-screen controlling module 902, a face center point calculating module 903 and a distribution adjusting module 904. The modules of the device of controlling distribution of multiple sub-screens 80 can include instructions executed by the processor 82 to achieve specific functions, and stored in the storage device 81.

The identity module 901 can be configured to capture at least one facial feature of at least one operator and a sub-screen controlling gesture posed by the at least one operator within a predefined area of the electronic device 1.

The sub-screen controlling module 902 can be configured to control the electronic device 1 to establish, merge, or delete the sub-screen according to the captured sub-screen controlling gesture, and store the relationship between the facial feature of the operator and the captured sub-screen.

As referred to FIG. 3-1, at least one facial feature of at least one operator and a sub-screen controlling gesture posed by the at least one operator within a predefined area of the electronic device are captured.

When only the first operator M enters the predefined area of the electronic device 1 and poses the sub-screen establishing gesture 10, the identify module 901 can be configured to control the capturing unit 84 to capture the sub-screen establishing gesture 10 posed by the first operator M and the facial feature of the first operator M. The sub-screen controlling module 902 can be configured to control the processor 82 of the electronic device 1 to establish the first sub-screen A corresponding to the first operator M according to the sub-screen establishing gesture 10 posed by the first operator M. The sub-screen controlling module 902 is further configured to control the storage device 81 to store the relationship between the facial feature of the first operator M and the first sub-screen A. Therein, the first sub-screen A can fully occupy the screen of the electronic device 1.

As referred to FIG. 3-2, when the first operator M is in the predefined area of the electronic device 1 and watching the first sub-screen A, and another second operator N is entering the predefined area of the electronic device 1 and posing the sub-screen establishing gesture 10, the identity module 901 can be configured to control the capturing unit 84 to capture the sub-screen establishing gesture 10 posed by the second operator N and the facial feature of the second operator N. The sub-screen controlling module 902 can be configured to control the processor 82 of the electronic device 1 to establish the second sub-screen B corresponding to the second operator N according to the sub-screen establishing gesture 10. The sub-screen controlling module 902 is further configured to control the storage device 81 to store the relationship between the facial feature of the second operator N and the second sub-screen B. Therein, the first sub-screen A and the second sub-screen B cooperatively cover the entire screen of the electronic device 1.

As referred to FIG. 3-3, when the first operator M is in the predefined area of the electronic device 1 and watching the first sub-screen A. The second operator N enters the predefined area of the electronic device and poses the sub-screen establishing gesture 10 at the same time as the first operator M, who is also posing the sub-screen establishing gesture 10. The identify module 901 can be configured to control the capturing unit 84 to capture the sub-screen establishing gestures 10 posed by the first operator M and the sub-screen establishing gesture 10 posed by the second operator N. The sub-screen controlling module 902 can be configured to control the processor 82 of the electronic device 1 to add the second operator N as the operator of the first sub-screen A according to the sub-screen establishing gesture 10 posed by the first operator M and the sub-screen establishing gesture 10 posed by the second operator N. The sub-screen controlling module 902 is further configured to control the storage device 81 to store the relationship between the facial feature of the second operator N and the first sub-screen A in addition to the relationship between the first operator M and the first sub-screen A.

As referred to FIG. 3-4, when the first operator M is in the predefined area and watching the first sub-screen A, and the second operator N is in the predefined area of the electronic device 1 and watching the second sub-screen B. If the second operator N poses the sub-screen establishing gesture 10 while the first operator M poses the sub-screen merging gesture 20 at the same time, the identify module 901 can be configured to control the capturing unit 84 to capture the sub-screen establishing gesture 10 posed by the second operator N and the sub-screen merging gesture 20 posed by the first operator M. The sub-screen controlling module 902 can be configured to control the processor 82 of the electronic device 1 to add the second operator N as the operator of the first sub-screen A according to the sub-screen establishing gesture 10 posed by the second operator N and the sub-screen merging gesture 20 posed by the first operator M. The sub-screen controlling module 902 is further configured to control the storage device 81 to store the relationship between the facial feature of the second operator N and the first sub-screen A, and delete the relationship between the facial feature of the second operator N and the second sub-screen B. At this time, the first sub-screen A is covering the screen of the electronic device 1 fully.

In at least one exemplary embodiment, when one of at least two operators, each having their own sub-screen, is posing the sub-screen merging gesture 20, and the other (or another) operators pose the sub-screen establishing gesture 10, the identify module 901 can be configured to control the capturing unit 84 to capture the sub-screen establishing gesture 10 posed by the one of at least two operators and the sub-screen merging gestures 20 posed by the other (or another) operators. The sub-screen controlling module 902 can be configured to control the processor 82 of the electronic device 1 to add the other (or another) operators as co-operators of the sub-screen related to the one of at least two operators according to the sub-screen establishing gesture 10 posed by the one of at least two operators and the sub-screen merging gestures 20 posed by the other (or another) operators. The sub-screen controlling module 902 is further configured to control the storage device 81 to store a relationship between the facial features of the other (or another) operators and the sub-screen related to the one of at least two operators.

As referred to FIG. 3-5, when the first operator M is in the predefined area of the electronic device 1 and watching the first sub-screen A, and the second operator N is in the predefined area of the electronic device and watching the second sub-screen B. If the second operator N poses the sub-screen deleting gesture 30, the identify module 901 can be configured to control the capturing unit 84 to capture the sub-screen deleting gesture 30. As the second sub-screen B has no other related operators, the sub-screen controlling module 902 can be configured to control the processor 82 of the electronic device 1 to delete the second sub-screen B according to the sub-screen deleting gesture 30 posed by the second operator N. The sub-screen controlling module 902 is further configured to control the storage device 81 to store the relationship between the facial feature of the second operator N and the second sub-screen B. As there are no other sub-screens, the first sub-screen A fully occupies the screen of the electronic device 1.

As referred to FIG. 3-6, when the first operator M and the second operator N are in the predefined area and watching the first sub-screen A, the second operator N is posing the sub-screen deleting gesture 30, the identify module 901 can be configured to control the capturing unit 84 to capture the sub-screen deleting gesture 30. Since first sub-screen A has another related first operator M, the sub-screen controlling module 902 can be configured to control the processor 82 of the electronic device 1 to delete the relationship between the facial feature of the second operator N and the first sub-screen A according to the sub-screen deleting gesture 30.

As referred to FIG. 3-7, when the first operator M is in the predefined area of the electronic device 1 and watching the first sub-screen A, while the second operator N is in the predefined area of the electronic device 1 and watching the second sub-screen B at the same time. If the second operator N leaves, and the second sub-screen B has no other related operators, the sub-screen controlling module 902 can be configured to control the processor 82 of the electronic device 1 to stop and/or hide the second sub-screen B.

As referred to FIG. 3-7, when the second operator N leaves, the second sub-screen B is suspended and/or hidden, the first operator M is watching the first sub-screen A. When the second operator N returns, the identify module 901 can be configured to control the capturing unit 84 to capture the facial feature of the second operator N to verify the identity of the operator. The sub-screen controlling module 902 can be configured to control the processor 82 of the electronic device 1 to display the second sub-screen B again when the identity of the operator has been verified.

The face center point calculating module 903 can be configured to control the electronic device 1 to track head positions of all operators relative to each sub-screen, and calculate a face center point of the head positions of all the operators relative to each sub-screen when the number of the sub-screens is greater than one.

The distribution adjusting module 904 can be configured to adjust distributions of all the sub-screens according to the face center point of each sub-screen.

The device of controlling distribution of multiple sub-screens 80 can further include a sub-screen operating module 905. The sub-screen operating module 905 can be configured to capture the sub-screen operating gesture 40 posed by the operator relative to each sub-screen, and control the sub-screen according to the sub-screen operating gesture 40. Therein, the sub-screen operating gesture 40 can include, but is not limited to, a mouse simulating gesture 41, a scroll gesture 42, a zoom gesture 43, a mute gesture 44, a return gesture 45, a homepage gesture 46, and so on.

When the identity module 901 captures the mouse simulating gesture 41, the sub-screen operating module 905 controls the electronic device 1 to transmit a mouse controlling command, such as a mouse moving command, a mouse clicking command or a mouse dragging command to the sub-screen related to the first sub-screen A related to the first operator M or the second sub-screen B related to the second operator N posing the mouse simulating gesture 41. The sub-screen operating module 905 further controls the cursor to act on the first sub-screen A related to the first operator M or the second sub-screen B related to the second operator N posing the mouse simulating gesture 41 according to the mouse controlling command.

When the identity module 901 captures the scroll-up gesture, the sub-screen operating module 905 controls the electronic device 1 to transmit a scroll-up command to the first sub-screen A related to the first operator M or the second sub-screen B related to the second operator N posing the scroll-up gesture, and further controls the first sub-screen A related to the first operator M or the second sub-screen B related to the second operator N posing the scroll-up gesture to page up according to the scroll-up command.

When the identity module 901 captures the scroll-down gesture, the sub-screen operating module 905 controls the electronic device 1 to transmit a scroll-down command to the first sub-screen A related to the first operator M or the second sub-screen B related to the second operator N posing the scroll-down gesture, and further controls the first sub-screen A related to the first operator M or the second sub-screen B related to the second operator N posing the scroll-down gesture to page down according to the scroll-down command.

When the identity module 901 captures the zoom-in gesture, the sub-screen operating module 905 controls the electronic device 1 to transmit a zoom-in command to the first sub-screen A related to the first operator M or the second sub-screen B related to the second operator N posing the zoom-in gesture, and further controls the first sub-screen A related to the first operator M or the second sub-screen B related to the second operator N posing the zoom-in gesture to zoom in according to the zoom-in command.

When the identity module 901 captures the zoom-out gesture, the sub-screen operating module 905 controls the electronic device 1 to transmit a zoom-out command to the first sub-screen A related to the first operator M or the second sub-screen B related to the second operator N posing the zoom-out gesture, and further controls the first sub-screen A related to the first operator M or the second sub-screen B related to the second operator N posing the zoom-out gesture to zoom out according to the zoom-out command.

When the identity module 901 captures the mute gesture 44 is captured, the sub-screen operating module 905 controls the electronic device 1 to transmit a mute command to the first sub-screen A related to the first operator M or the second sub-screen B related to the second operator N posing the mute gesture 44, and further controls the first sub-screen A related to the first operator M or the second sub-screen B related to the second operator N posing the mute gesture 44 to be muted according to the mute command.

When the identity module 901 captures the return gesture 45, the sub-screen operating module 905 controls the electronic device 1 to transmit a return command to the first sub-screen A related to the first operator M or the second sub-screen B related to the second operator N posing the return gesture 45, and further controls the first sub-screen A related to the first operator M or the second sub-screen B related to the second operator N posing the return gesture 45 to return to previous page according to the returning command.

When the identity module 901 captures the homepage gesture 46, the sub-screen operating module 905 controls the electronic device 1 to transmit a homepage command to the first sub-screen A related to the first operator M or the second sub-screen B related to the second operator N posing the homepage gesture 46, and further controls the first sub-screen A related to the first operator M or the second sub-screen B related to the second operator N posing the homepage gesture 46 to return to homepage according to the homepage command.

As referred to FIG. 9, the device of controlling distribution of multiple sub-screens 80 can further include an icon-displaying module 906. The icon-displaying module 906 can be configured to control the display screen 83 to display the small icon of the operator relative to the sub-screen on the top right corner of the sub-screen.

Therein, in at least one exemplary embodiment, the icon-displaying module 906 is further configured to control the display screen 83 to display the small icon of the operator relative to the displaying sub-screen on the top right corner of the sub-screen. However, the icon-displaying module 906 can be further configured to control the display screen 83 to display the small icon of the operator relative to the hidden or suspended sub-screen on the lower right corner of the screen of the electronic device.

In at least one exemplary embodiment, the icon-displaying module 906 is further configured to control the display screen 83 to display the small icon of the operator relative to the displaying sub-screen with one color. In at least one exemplary embodiment, the icon-displaying module 906 is further configured to control the display screen 83 to display the small icon of the operator relative to the hiding sub-screen with another corner different with the one color.

The exemplary embodiments shown and described above are only examples. Many details are often found in the art such as the features of method of controlling distribution of multiple sub-screens and device using the same. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A method of controlling distribution of multiple sub-screens, applied on an electronic device, the multiple sub-screens comprising at least a first sub-screen associated with at least a first operator and at least a second sub-screen associated with at least a second operator, the method comprising:
tracking a first head position of the first operator relative to the first sub-screen, and calculating a first face center point of the first head position, and tracking a second head position of the second operator relative to the second sub-screen, and calculating a second face center point of the second head position; and
adjusting distributions of the first sub-screen and the second sub-screen according to the first face center point and the second face center point.

2. The method of claim 1, wherein adjusting distributions of the first sub-screen and the second sub-screen according to the first face center point and the second face center point comprises:
calculating a sum of distances, a distance between a first distribution center and a first face center point or a second face center point and a distance between a second distribution center and a second face center point or a first face center point of each distribution manner; selecting the distribution manner having a minimum sum; and
adjusting the distributions of the first sub-screen and the second sub-screen according to the distribution manner having the minimum sum.

3. The method of claim 1, wherein the method further comprises:
capturing a sub-screen operating gesture posed by the first operator relative to the first sub-screen or the second operator relative to the second sub-screen; wherein the sub-screen operating gesture comprises a mouse simulating gesture, the mouse simulating gesture comprises a mouse moving gesture, a mouse clicking gesture, and a mouse dragging gesture, the mouse moving gesture is movement of an open palm, the mouse clicking gesture is clenching of a fist, and the mouse dragging gesture is movement of the clenched fist;
transmitting a mouse controlling command selected from a group consisting of a mouse moving command, a mouse clicking command and a mouse dragging command to the first sub-screen related to the first operator or the second sub-screen related to the second operator posing the mouse simulating gesture; and
controlling a cursor to act on the first sub-screen related to the first operator or the second sub-screen related to the second operator posing the mouse simulating gesture according to the mouse controlling command.

4. The method of claim 1, wherein the method further comprises:
capturing a sub-screen operating gesture posed by the first operator relative to the first sub-screen or the second operator relative to the second sub-screen, wherein the sub-screen operating gesture comprises a scroll-up gesture, and the scroll-up gesture is a hand waving towards left;
transmitting a scroll-up command to the first sub-screen related to the first operator or the second sub-screen related to the second operator posing the scroll-up gesture; and
controlling the first sub-screen related to the first operator or the second sub-screen related to the second operator posing the scroll-up gesture to page up according to the scroll-up command.

5. The method of claim 4, wherein the sub-screen operating gesture further comprises a scroll-down gesture, the scroll-down gesture is the hand waving towards right, the method further comprises:
transmitting a scroll-down command to the first sub-screen related to the first operator or the second sub-screen related to the second operator posing the scroll-down gesture; and
controlling the first sub-screen related to the first operator or the second sub-screen related to the second operator posing the scroll-down gesture to page down according to the scroll-down command.

6. The method of claim 1, wherein the method further comprises:
capturing a sub-screen operating gesture posed by the first operator relative to the first sub-screen or the second operator relative to the second sub-screen; wherein the sub-screen operating gesture comprises a zoom-in gesture, the zoom-in gesture is two hands moving away from each other;
transmitting a zoom in command to the first sub-screen related to the first operator or the second sub-screen related to the second operator posing the zoom-in gesture; and
controlling the first sub-screen related to the first operator or the second sub-screen related to the second operator posing the zoom-in gesture to zoom in according to the zoom-in command.

7. The method of claim 6, wherein the sub-screen operating gesture further comprises a zoom-out gesture, the zoom-out gesture is the two hands moving close to each other, the method further comprises:
transmitting a zoom-out command to the first sub-screen related to the first operator or the second sub-screen related to the second operator posing the zoom-out gesture; and
controlling the first sub-screen related to the first operator or the second sub-screen related to the second operator posing the zoom-out gesture to zoom out according to the zoom-out command.

8. The method of claim 1, wherein the method further comprises:
capturing a sub-screen operating gesture posed by the first operator relative to the first sub-screen or the second operator relative to the second sub-screen; wherein the sub-screen operating gesture comprises a mute gesture, the mute gesture is having an index finger in front of a mouth;
transmitting a mute command to the first sub-screen related to the first operator or the second sub-screen related to the second operator posing the mute gesture; and
controlling the first sub-screen related to the first operator or the second sub-screen related to the second operator posing the mute gesture to be muted according to the mute command.

9. The method of claim 1, wherein the method further comprises:
capturing a sub-screen operating gesture posed by the first operator relative to the first sub-screen or the second operator relative to the second sub-screen; wherein the sub-screen operating gesture comprises a return gesture, the return gesture is an open palm turning anticlockwise;
transmitting a returning command to the first sub-screen related to the first operator or the second sub-screen related to the second operator posing the return gesture; and
controlling the first sub-screen related to the first operator or the second sub-screen related to the second operator posing the return gesture to return to a previous page according to the returning command.

10. The method of claim 1, wherein the method further comprises:
capturing a sub-screen operating gesture posed by the first operator relative to the first sub-screen or the second operator relative to the second sub-screen; wherein the sub-screen operating gesture comprises a homepage gesture, and the homepage gesture is a thumb pointing up;
transmitting a homepage command to the first sub-screen related to the first operator or the second sub-screen related to the second operator posing the homepage gesture; and
controlling the first sub-screen related to the first operator or the second sub-screen related to the second operator posing the homepage gesture to return to homepage according to the homepage command.

11. A device of controlling distribution of multiple sub-screens, the multiple sub-screens comprising at least a first sub-screen associated with at least a first operator and at least a second sub-screen associated with at least a second operator, the device comprising:
a plurality of processors; and
a plurality of non-transitory computer storage mediums, coupled to the plurality of processors and configured to store instructions for execution by the plurality of processors, the instructions causing the plurality of processors to:
track a first head position of the first operator relative to the first sub-screen, and calculating a first face center point of the first head position, and track a second head position of the second operator relative to the second sub-screen, and calculating a second face center point of the second head position; and
adjust distributions of the first sub-screen and the second sub-screen according to the first face center point and the second face center point.

12. The device of claim 11, wherein the instructions cause the plurality of processors to
calculate a sum of distances, a distance between a first distribution center and a first face center point or a second face center point and a distance between a second distribution and a second face center point or a first face center point of each distribution manner,
select the distribution manner having a minimum sum; and
adjust the distributions of the first sub-screen and the second sub-screen according to the distribution manner having the minimum sum.

13. The device of claim 11, wherein the instructions cause the plurality of processors to:
capture a sub-screen operating gesture posed by the first operator relative to the first sub-screen or the second operator relative to the second sub-screen, wherein the sub-screen operating gesture comprises a mouse simulating gesture, the mouse simulating gesture comprises a mouse moving gesture, a mouse clicking gesture, and a mouse dragging gesture, the mouse moving gesture is movement of an open palm, the mouse clicking gesture is clenching of a fist, and the mouse dragging gesture is movement of the clenched fist;
transmit a mouse controlling command selected from a group consisting of a mouse moving command, a mouse clicking command and a mouse dragging command to the first sub-screen related to the first operator or the second sub-screen related to the second operator posing the mouse simulating gesture; and
control a cursor to act on the first sub-screen related to the first operator and the second sub-screen related to the second operator posing the mouse simulating gesture according to the mouse controlling command.

14. The device of claim 11, wherein the instructions cause the plurality of processors to:
capture a sub-screen operating gesture posed by the first operator relative to the first sub-screen or the second operator relative to the second sub-screen, wherein the sub-screen operating gesture comprises a scroll-up gesture, the scroll-up gesture is hand waving towards left;
transmit a scroll-up command to the first sub-screen related to the first operator or the second sub-screen related to the second operator posing the scroll-up gesture; and
control the first sub-screen related to the first operator or the second sub-screen related to the second operator posing the scroll-up gesture to page up according to the scroll-up command.

15. The device of claim 14, wherein the sub-screen operating gesture further comprises a scroll-down gesture, the scroll-down gesture is the hand waving towards right, the instructions cause the plurality of processors to:
transmit a scroll-down command to the first sub-screen related to the first operator or the second sub-screen related to the second operator posing the scroll-down gesture; and
control the first sub-screen related to the first operator or the second sub-screen related to the second operator posing the scroll-down gesture to page down according to the scroll-down command.

16. The device of claim 11, wherein the instructions cause the plurality of processors to:
capture a sub-screen operating gesture posed by the first operator relative to the first sub-screen or the second operator relative to the second sub-screen, wherein the sub-screen operating gesture comprises a zoom-in gesture, the zoom-in gesture is two hands moving away from each other;
transmit a zoom in command to the first sub-screen related to the first operator or the second sub-screen related to the second operator posing the zoom-in gesture; and
control the first sub-screen related to the first operator or the second sub-screen related to the second operator posing the zoom-in gesture to zoom in according to the zoom-in command.

17. The device of claim 16, wherein the sub-screen operating gesture further comprises a zoom-out gesture, the zoom-out gesture is the two hands moving close to each other, the instructions cause the plurality of processors to:
transmit a zoom-out command to the first sub-screen related to the first operator or the second sub-screen related to the second operator posing the zoom-out gesture; and
control the first sub-screen related to the first operator or the second sub-screen related to the second operator posing the zoom-out gesture to zoom out according to the zoom-out command.

18. The device of claim 11, wherein the instructions cause the plurality of processors to:
capture a sub-screen operating gesture posed by the first operator relative to the first sub-screen or the second operator relative to the second sub-screen, wherein the sub-screen operating gesture comprises a mute gesture, the mute gesture is having an index finger in front of a mouth;
transmit a mute command to the first sub-screen related to the first operator or the second sub-screen related to the second operator posing the mute gesture; and
control the first sub-screen related to the first operator and the second sub-screen related to the second operator posing the mute gesture to be muted according to the mute command.

19. The device of claim 11, wherein the instructions cause the plurality of processors to:
capture a sub-screen operating gesture posed by the first operator relative to the first sub-screen or the second operator relative to the second sub-screen, wherein the sub-screen operating gesture comprises a return gesture, the return gesture is an open palm turning anticlockwise;
transmit a returning command to the first sub-screen related to the first operator or the second sub-screen related to the second operator posing the return gesture; and
control the first sub-screen related to the first operator or the second sub-screen related to the second operator posing the return gesture to return to a previous page according to the returning command.

20. The device of claim 11, wherein the instructions cause the plurality of processors to:
capture a sub-screen operating gesture posed by the first operator relative to the first sub-screen or the second operator relative to the second sub-screen, wherein the sub-screen operating gesture comprises a homepage gesture, the homepage gesture is thumb pointing up;
transmit a homepage command to the first sub-screen related to the first operator or the second sub-screen related to the second operator posing the homepage gesture; and
control the first sub-screen related to the first operator or the second sub-screen related to the second operator posing the homepage gesture to return to homepage according to the homepage command.
